(19) United States
(12) Patent Application Publication
(10) Pub. No.: US 2025/0103879 A1
(43) Pub. Date: Mar. 27, 2025

(54) NEAR REAL-TIME VECTOR INDEX BUILDING AND SERVING SOLUTION

(71) Applicant: PayPal, Inc., San Jose, CA (US)

(72) Inventors: Zhibin Yuan, Shanghai (CN); Qin Qian, Shanghai (CN); Yang Hu, Shanghai (CN); Haoran Zhang, Shanghai (CN); Ke Zheng, Shanghai (CN)

(21) Appl. No.: 18/475,945

(22) Filed: Sep. 27, 2023

(51) Int. Cl. G06N 3/08; G06N 3/042

(52) U.S. Cl. CPC G06N 3/08; G06N 3/042

(57) ABSTRACT

Systems, methods, and computer program for generating and using embedding vectors associated with real-time data are provided. A streaming platform receives streaming data associated with events occurring in a network environment. At least one neural network generates embedding vectors from the streaming data associated with the events. The analytical models analyze the embedding vectors and are updated with the result from the analysis. Embedding vectors are also associated with one or more indexes. The streaming platform may receive a query with an embedding vector associated with data from another event that is occurring in real-time in the network. Based on the embedding vector in the query, the streaming platform may use the one or more indexes to provide, in real-time, similar embedding vectors, which are indicative of similar events in the network environment.

### TECHNICAL FIELD

The disclosure generally relates to machine learning systems, and more specifically to using embedding vectors generated by the machine learning systems to identify similar items in real-time.

### BACKGROUND

Big data and fast data are becoming key factors in the machine learning systems. As the data is often unstructured data, machine learning systems convert the unstructured data into embedding vectors. Conventional machine learning systems may receive data in batches on daily or weekly basis and generate embedding vectors from the data. When the machine learning systems generate embedding vectors in batches, the machine learning systems may not react timely to certain activity. For example, the machine learning systems may not react timely to high-velocity fraud attacks that may be detected with the embedding vectors associated with real-time data. In another example, machine learning systems may not be able to make real-time product recommendations because the machine learning systems may not have the current embedding vectors associated with product offers that may last a few hours.

### BRIEF DESCRIPTION OF THE DRAWINGS

FIG. 1 is an exemplary system where various embodiments can be implemented.

FIG. 2A illustrates components of a streaming platform, according to some embodiments.

FIG. 2B is a block diagram illustrating an index, according to some embodiments.

FIG. 3 is a flow diagram for generating embedding vectors from real-time data and batch data, according to some embodiments.

FIG. 4 is a diagram of an example vector query and query response, according to some embodiments.

FIG. 5 is a flow diagram for using embedding vectors to provide real-time recommendations, according to some embodiments.

FIG. 6 is a diagram of an example search query and search response, according to some embodiments.

FIG. 7 is a diagram of a display illustrating an interface with an item recommended using an embedding vector of another item in real-time, according to some embodiments.

FIG. 8 is a diagram of an item recommended using embedding vectors of other items in real-time, according to some embodiments.

FIG. 9 is a flowchart of a method for generating an embedding vector in real time, according to some embodiments.

FIG. 10 is a flowchart of a method for recommending an item using an embedding vector of another item, according to some embodiments.

FIG. 11 is a block diagram of a computer system suitable for implementing one or more components or operations in FIGS. 1-10 according to some embodiments.

Embodiments of the disclosure and their advantages are best understood by referring to the detailed description that follows. It should be appreciated that like reference numerals are used to identify like elements illustrated in one or more of the figures, wherein showings therein are for purposes of illustrating embodiments of the disclosure and not for purposes of limiting the same.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

The embodiments are directed to machine learning systems that receive, process and analyze data in real-time. The machine learning systems may include a streaming platform that receives data associated with events as events occur in a network environment. The data is typically unstructured data. Unstructured data is data that is not arranged according to a pre-existing format or schema and may include text data, multimedia data, and the like. The streaming platform may use trained neural network models to convert the data associated with events in the network environment into embedding vectors. The streaming platform may add one or more indices on keys, embeddings, and different attributes within the embedding vectors. The indices may be used by the streaming platform to access and analyze the embedding vectors in real-time. Additionally, the streaming platform may also include various analytical models that may use indices set on the attributes or embeddings in the embedding vectors to identify patterns and similar embedding vectors, and also perform velocity calculations using the embedding vectors. The streaming platform may store the embedding vectors associated with the events, the indices, and the results from the analytical models in a vector storage.

As another event occurs in a network environment, a device associated with the event may query the vector storage in real-time, e.g., as the event is occurring, and identify embedding vectors of data associated with other events that are similar to the event. Using the embedding vectors associated with other events, the device may identify data from the other events that is similar to the event that is occurring in the network environment. The data from the similar events may be used in different ways. The data from similar events may be used to identify fraud. For example, a transaction that occurs in real time may be identified as fraudulent because the transaction is similar to other transactions that have been identified as fraudulent. In another example, data associated with similar events may be recommendations for products that are similar to a product that a user is currently browsing or purchasing using a device in a network environment. Notably, the examples above are not limiting, and the streaming platform may be employed by other applications that identify similar events using embedding vectors for various purposes.

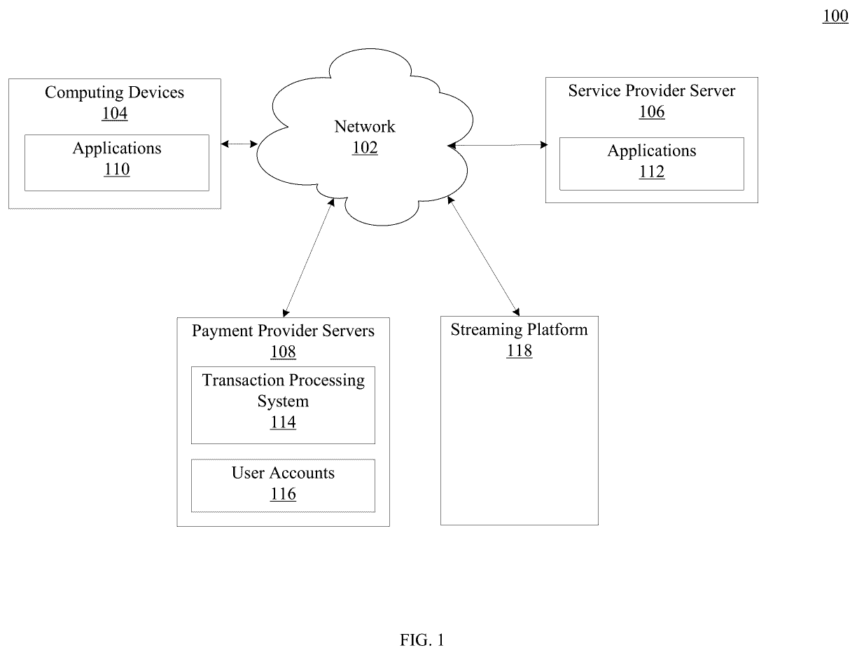

FIG. 1 is an exemplary system 100 where embodiments can be implemented. System 100 may be a network environment that includes multiple computing devices connected by one or more networks. For example, system 100 includes a network 102. Network 102 may be implemented as a single network or a combination of multiple networks. In various embodiments, network 102 may include the Internet or one or more intranets, landline networks, wireless networks, and/or other appropriate types of networks. Network 102 may be a small-scale communication network, such as a private or local area network, or a larger scale network, such as a wide area network.

Various components that are accessible to network 102 may be computing device(s) 104, service provider server(s) 106, and payment provider server(s) 108. Computing devices 104 may be portable and non-portable electronic devices under the control of a user and configured to transmit, receive, and manipulate data from service provider server(s) 106 and payment provider server(s) 108 over network 102. Example computing devices 104 include desktop computers, laptop computers, tablets, smartphones, wearable computing devices, eyeglasses that incorporate computing devices, implantable computing devices, etc.

Computing devices 104 may include one or more applications 110. Applications 110 may be pre-installed on the computing devices 104, installed on the computing devices 104 using portable memory storage devices, such as compact disks or thumb-drives, or be downloaded to the computing devices 104 from service provider server(s) 106, payment provider server(s) 108, and/or other devices in system 100. Applications 110 may execute on computing devices 104 and receive instructions and data from a user, from service provider server(s) 106, and payment provider server(s) 108 via input devices or network 102.

Example applications 110 may be payment transaction applications. Payment transaction applications may be configured to transfer money world-wide, receive payments for goods and services, manage money spending, etc. Further, applications 110 may be under an ownership or control of a payment service provider, such as PAYPAL®, Inc. of San Jose, CA, USA, a telephonic service provider, a social networking service provider, and/or other service providers. Applications 110 may also be analytics applications. Analytics applications perform business logic, provide services, and measure and improve performance of services and functions of other applications that execute on computing devices 104 based on current and historical data. Applications 110 may also be security applications for implementing client-side security features, detecting fraudulent events, and the like. Applications 110 may be communication applications, such as email, texting, voice, and instant messaging applications that allow a user to send and receive emails, calls, texts, and other notifications through network 102, and the like. Applications 110 may be location detection applications, such as mapping, compass, and/or global positioning system (GPS) applications, social networking applications and/or merchant applications. Additionally, applications 110 may be service applications that permit a user of computing device 104 to receive, request and/or view information for products and/or services and permit the user to purchase the selected products and/or services.

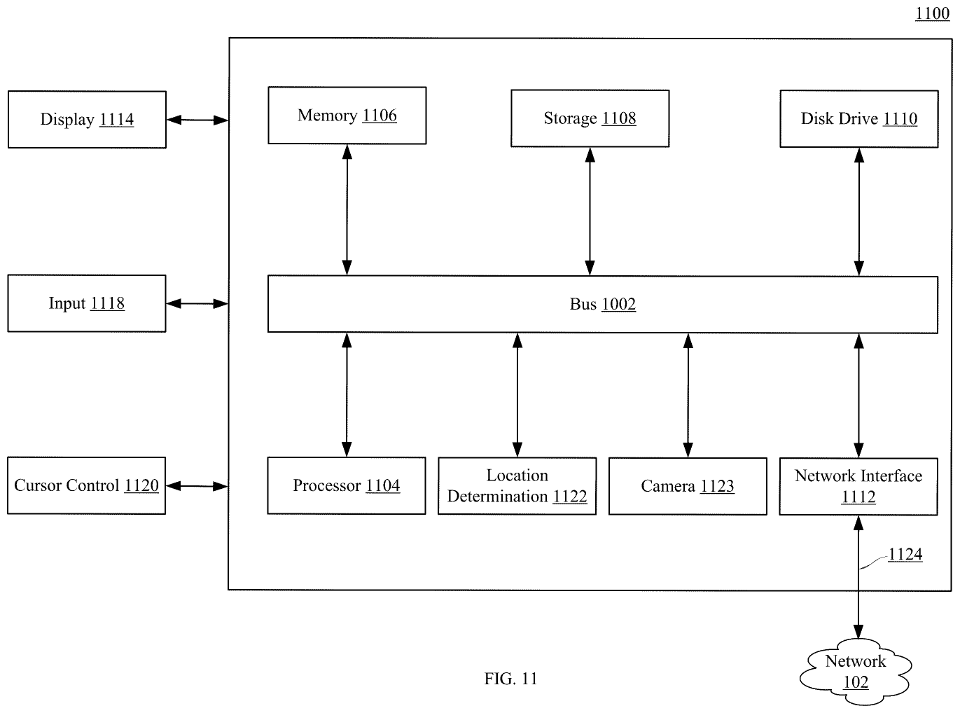

In an embodiment, applications 110 may utilize numerous components included in computing device 104 to receive input, store and display data, and communicate with network 102. Example components are discussed in detail in FIG. 11.

As discussed above, one or more service provider servers 106 may be connected to network 102. Service provider server 106 may also be maintained by a service provider, such as PAYPAL®, a telephonic service provider, social networking service, and/or other service providers. Service provider server 106 may be software that executes on a computing device configured for large scale processing and that provides functionality to other computer programs, such as applications 110 and applications 112 discussed below.

In an embodiment, service provider server 106 may initiate and direct execution of applications 112. Applications 112 may be counterparts to applications 110 executing on computing devices 104. Applications 112 may receive data and provide data to applications 110, may recommend items to application 110, and may process transactions on behalf of applications 110. Applications 112 may be financial services applications configured to transfer money world-wide, receive payments for goods and services, manage money spending, etc. Applications 112 may be security applications configured to implement client-side security features, detect fraud, and the like, on behalf of applications 110. Applications 112 may be communication applications that perform email, texting, voice, and instant messaging functions that allow a user to send and receive emails, calls, texts, and other notifications over network 102. Applications 112 may be location detection applications, such as a mapping, compass, and/or GPS applications. Applications 112 may also be incorporated into social networking applications and/or merchant applications. Applications 112 may be recommendation applications that recommend similar items or products to applications 110.

In an embodiment, applications 110 and applications 112 may process transactions on behalf of a user. In some embodiments, to process transactions, applications 110, 112 may request payments for processing the transactions via payment provider server(s) 108. For instance, payment provider server 108 may be a software application that is configured to receive requests from applications 110, 112 that cause the payment provider server 108 to transfer funds of a user using application 110 to service provider associated with application 112. Thus, applications 110 and 112 may receive user data, including user authentication data, for processing any number of electronic transactions, such as through payment provider server 108.

In an embodiment, payment provider servers 108 may be maintained by a payment provider, such as PAYPAL®. Other payment provider servers 108 may be maintained by or include a merchant, financial services provider, credit card provider, bank, and/or other payment provider, which may provide user account services and/or payment services to a user. Although payment provider servers 108 are described as separate from service provider server 106, it is understood that one or more of payment provider servers 108 may include services offered by service provider server 106 and vice versa.

Each payment provider server 108 may include a transaction processing system 114. Transaction processing system 114 may correspond to processes, procedures, and/or applications executable by a hardware processor. In an embodiment, transaction processing system 114 may be configured to receive information from one or more applications 110 executing on computing devices 104 and/or applications 112 executing on service provider server 106 for processing and completion of financial transactions. Financial transactions may include financial information corresponding to user debit/credit card information, checking account information, a user account (e.g., payment account with a payment provider server 108), or other payment information. Transaction processing system 114 may complete the financial transaction for the purchase request by providing payment to application 112 executing on service provider server 106.

Payment provider server 108 may also include user accounts 116. Each user account 116 may be established by one or more users using applications 110 with payment provider server 108 to facilitate payment for goods and/or services offered by applications 112. User accounts 116 may include user information, such as name, address, birthdate, payment/funding information, travel information, additional user financial information, and/or other desired user data. In a further embodiment, user accounts 116 may be stored in a database or another memory storage described in detail in FIG. 11.

In some embodiments, applications 110, 112 may generate events. Events may be real-time events that reflect user or third party interactions with application 110. Events may also be initiated by applications 112. For example, application 110 that is a payment application may generate events when a user enters user information as payment for a transaction, a user initiates a transaction, e.g., by purchasing one or more items or services, or view a receipt for the transaction. Application 112 may generate events by providing items, e.g., products, or services to application 110. Applications 110, 112 that are security applications may generate events when application 110, 112 receive messages for transactions that indicate fraudulent and/or authentic accesses. Applications 110, 112 that are communication applications may generate events by generating user emails, texts, voice transcriptions, and the like. Applications 110, 112 that are location detection applications may generate events when computing devices are identified at certain locations, when users enter geo-location queries, and the like. Applications 110, 112 that are merchant applications may generate events when application 110 receives items from application 112, a user browses applications 110 that digitally displays items, a user digitally places items into a check out cart, digitally purchases items, and the like. Social networking applications 110, 112 may generate events when a user connects to application 110, enters or views posts, enters reactions to the post, and the like. Depending on application 112, events may also include data associated with various items including products, texts, documents, images, audios, and the like.

In some embodiments, events may be analyzed to improve user experience, detect fraud, provide personalized user experience, e.g., provide recommendations for items that are similar to the item a user is browsing or purchasing, ensure system compliance, and the like. The events may also be analyzed to determine similar items, including products, texts, documents, images, audios, and the like. For example, suppose application 112 is a recommendation application of a merchant. Application 112 may generate numerous campaigns activities that are organized every minute, hour, etc., and the like. These campaigns may include a new promotion, a new item, product, or service, a new personalized experience, and the like. Each of the campaigns may correspond to an event. Identifying events that may be of interest to a consumer and providing recommendations for those events may provide a personalized consumer experience, save consumer time and money, and improve the checkout success rate. Identifying events that may be of interest to a consumer and providing recommendations for those events may also help merchant retain customers and improve revenue.

In another example, suppose application 112 is a security application that detects fraud. There may be numerous transactions that are occurring in system 100. Identifying transactions in real-time that may be indicative of fraud by comparing them to similar known fraudulent transactions may prevent or reduce fraud occurring in real time, thus improving consumer satisfaction and reducing revenue loss to the merchant, and monetary loss to consumer.

In some embodiments, system 100 may include a streaming platform 118. Streaming platform 118 may receive data associated with events from applications 110, 112 in system 100, convert data in the events to embedding vectors, and store the embedding vectors in a vector storage. Streaming platform 118 may receive data associated with events as the events are occurring, in real-time or as close to real-time as possible in system 100, such as within a predetermined number of seconds (e.g., 10 seconds) or a minute depending on a type of application 110, and convert the data to embedding vectors. The streaming platform 118 may then identify similar embedding vectors to embedding vectors and provide the data that correspond to the similar embedding vectors back to applications 110, 112 in real time or upon request.

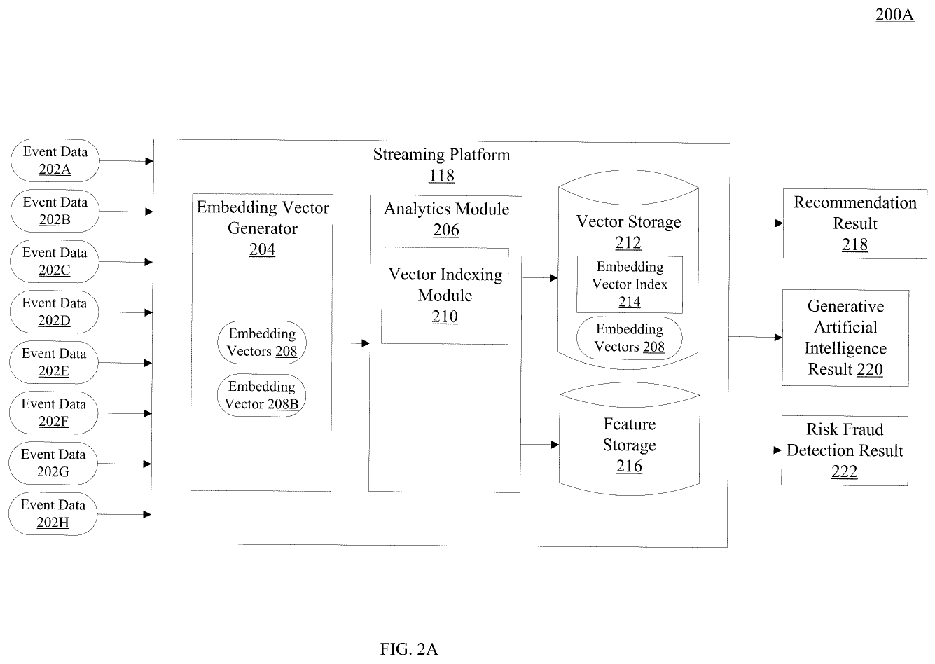

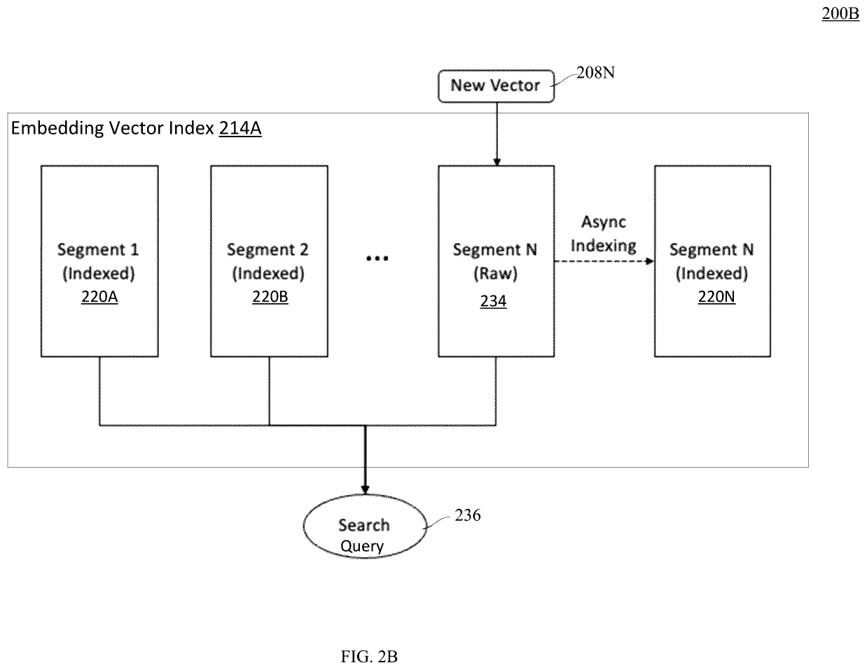

FIG. 2A is a block diagram 200A of a streaming platform, according to some embodiments. As discussed above, streaming platform 118 receives data. The data may be associated events and include information associated with transactions, user behavior, user identify, various funding instruments, risk evaluation, case lifecycle, partnership lifecycle, and log data. Streaming platform 118 may receive data in real-time or as close to real-time as technologically possible, e.g., every 5 or 10 seconds, every minute, and the like, from various applications 110, 112. Streaming platform 118 may also receive data during a time an event is occurring. For example, as a user is interacting with application 110, the user may receive information associated with another event in system 100.

FIG. 2A illustrates various types of event data 202, such as event data 202A-H, that streaming platform 118 receives and converts to embedding vectors. Event data 202A may be transaction data, event data 202B may be user behavior data, event data 202C may be user identify data, event data 202D may be funding instrument data, event data 202E may be risk evaluation data, event data 202F may be case lifecycle data, event data 202G may be partnership data, and event data 202H may be log data.

Streaming platform 118 may include an embedding vector generator 204 and an analytics module 206. Embedding vector generator 204 may be computer software and/or hardware that generates embedding vectors 208 from event data 202A-H. In some instances, embedding vector generator 204 may use embedding technology, particular artificial intelligence and neural network technology, such as Word2Vec, FastText, convolution neural network models, and/or Bidirectional Encoder Representations of Transformers (BERT) models to generate embedding vector 208 from text, documents, images, etc. Embedding vectors 208 are vectors of attributes (e.g., integer or real numbers) that capture meaning and relationships in event data 208A-H. Embedding vector generator 204 may be trained to select a subset of data in event data 202A-H to generate embedding vectors 208. For example, for event data 202A that includes transaction data, embedding vector generator 204 may select attributes associated with product information, timestamp, merchant information, and the like. In another example, for event data 202C that includes user identity data, embedding vector generator 204 may select attributes associated with a user name (or another identity attribute), age, address, etc. Embedding vector generator 204 may generate one embedding vector in embedding vectors 208 for each event data in event data 202A-H or multiple embedding vectors 208 that represent relationships between different attributes in event data 202A-H. Embedding vector generator 204 may also filter embedding vectors 208 according to predefined criteria, deduplicate embedding vectors 208 that are the same, and normalize embedding vector 208 such that the sum of the attributes or embeddings within embedding vector 208 is set to a predefined number, such as one.

In some instances, prior to embedding vector generator 204 generating embedding vectors 208, streaming platform 118 may pre-process the data in event data 202A-H. For example, streaming platform 118 may decrypt data, remove duplicative data, convert text in events data 202A-H to all lower case text, remove special characters, remove or include characters for null or invalid data, anonymize data when applicable, deserialize data and the like.

Embedding vector generator 204 may pass embedding vectors 208 to analytics module 206. Analytics module 206 may be software and/or hardware that includes a vector indexing module 210 and performs various compute functions. Once analytics module 206 receives embedding vectors 208 from embedding vector generator 204, vector indexing module 210 may generate or assign one or more indexes, such as embedding vector index 214, to embedding vectors 208 or on one or more embeddings within the embedding vectors 208. Vector indexing module 210 may also assign embedding vectors to existing index and update the existing index. In some embodiments, vector indexing module 210 may generate embedding vector index 214 tailored to different analytical models to make embedding vector analysis and subsequent retrieval more efficient. In one embodiment, vector indexing module 210 may generate embedding vector index 214 that is compatible with a k-nearest-neighbor (KNN) algorithm for searching embedding vectors 208 that are similar to another embedding vector. In another embodiment, vector indexing module 210 may generate embedding vector index 214 that is compatible with an approximate nearest neighbor search (ANN) algorithm for searching embedding vectors 208. The ANN algorithm may search large datasets efficiently. In yet another embodiment, vector indexing module 210 may generate embedding vector index 214 that facilitates access to embedding vector in the embedding vectors 208 based on one or more criteria. Once embedding vectors 208 are associated with one or more indices, analytics module 206 may access, analyze and retrieve embedding vectors 208 using the indices, and respond to search and/or similarity queries on demand. In non-limiting examples, analytics module 206 may use embedding vector index 214 to generate a recommendation result 218, a generative artificial intelligence result 220, or a risk fraud detection result 222, as discussed in further detail below.

As discussed above, example indices may be embedding vector indexes 214. Embedding vector indexes 214 and embedding vectors 208 may be stored in a vector storage 212, e.g., a database or another memory storage conducive for storing and retrieving large amount of data. In some instances, a subset of embedding vector indexes 214 and embedding vectors 208 may also be stored in a cache memory for faster accesses. In some instances, embedding vector indexes 214 and embedding vectors 208 may be stored in namespaces. A namespace may include a subset of embedding vectors 208 and corresponding indices. The embedding vectors 208 within the namespace may be accessed using the indices associated with the namespace.

FIG. 2B is a block diagram 200B of an embedding vector index that may be included in embedding vector indexes 214, according to some embodiments. FIG. 2B illustrates one of embedding vector indexes 214, such as an embedding vector index 314A that may be an ANN index. Embedding vector index 214A may include multiple segments, such as segments 220A-N. Segments 220A-N may be built sequentially, with segment 220A being built first, segment 220B being built second, and so forth. Although the embodiments describe an ANN index, the embodiments are also applicable to other types of indexes.

As building an index is a time consuming process which may interfere with an embedding vector search and may not be performed in real-time, vector indexing module 210 may built each segment in segments 220A-N asynchronously. For example, suppose vector indexing module 210 receives embedding vector 208N. Prior to receiving embedding vector 208N, vector indexing module 210 may have already generated and indexed segments 220A-M using embedding vectors 208 received prior to embedding vector 208N. Segment 220N, however, has not yet been generated and indexed. Upon receiving embedding vector 208N, vector indexing module 210 may insert embedding vector 208N into unindexed segment 234 with other raw data. The raw data may include embedding vectors that vector indexing module 210 has received after generating an indexed segment 220M, but that have yet been indexed in segment 220N. When a search query 236 for one of the embedding vectors arrives (as discussed in further detail below), the query search may use the indexed search to search segments 220A-M and a brute force search to search unindexed segment 234. When the number of embedding vectors in unindexed segment 234 increases to at or above a predefined threshold, vector indexing module 210 may asynchronously convert unindexed segment 234 into indexed segment 220N. Vector indexing module 210 may also generate a new unindexed segment (e.g., unindexed segment 2200 (not shown) to store raw data. Such approach does not significantly affect a search for an embedding vector because unindexed segment 234 is relatively small compared to segments 220A-M. Accordingly, the impact of the brute force search on segment 234 and an index search on segments 220A-M is relatively small and can still be performed in real time. Once vector indexing module 210 converts segment 234 into indexed segment 220N, an indexed search may be performed on segment 220N as well.

As discussed above, analytics module 206 may perform analytics on embedding vectors 208. In one embodiment, analytics module 206 may receive embedding vectors 208 (or retrieve embedding vectors 208 from embedding vector indexes 214) and set velocity counters on the embedding vectors 208. For example, analytics module 206 may determine a number of times a user accessed an account, a number of time a transaction from a particular IP address took place, a number of time a particular item, brand, etc., was purchased, and the like. The analytics module 206 may also include various functions, including a minimum function, maximum function, average function, rate of decay function, a percent function and others in order to manipulate various velocity counters, and perform analytics on the embedding vectors 208.

For example, suppose event data 202B includes a user uploading a document as part of an account registration process. The embedding vector generator 204 may generate an embedding vector 202B that is associated with event data 202B. Analytics module 206 may identify similar documents based on embedding vector 202B and embedding vectors 208 of the similar documents. From the similar documents, analytics module 206 may determine whether the similar documents refer to the same documents as in event data 202B, and use the velocity counter to determine the number of times a picture within the document occurred during account registration. If the velocity counter is above a predefined maximum count threshold, the account registration event associated with event data 202B may be a fraudulent event and may be flagged for further review in risk fraud detection result 222.

In another embodiment, analytics module 206 may include an event sequence model. The event sequence model may receive embedding vectors 208 and determine a sequence that may occur when a user navigates application under specific scenarios, e.g., a use navigates an electronic shopping application but before the transaction event occurs. Event sequence model may use the sequences to identify patterns, e.g., patterns that indicate fraud, shopping patterns, transaction patterns, and the like.

Event sequence model may also cluster similar patterns into clusters or groups. For example, suppose a user takes time-series actions with an application 110 executing on computing device 104 discussed in FIG. 1. The actions may be a user logging into the application, adding a method of payment, checking out, transferring money, and the like. Each action may be event data 202B for which embedding vector generator 204 may generate embedding vector 208B. The embedding vector may include user's properties and a model score associated with the action. The time-series actions from login to checkout and/or to other actions may be viewed as a sequence of embedding vectors 208. The embedding vectors 208 may be an input to a new event sequence model or be used for clustering or pattern matching. For example, for a fraudulent use case, the event sequence model may identify a fraudulent event sequence and may compare the event sequence associated with embedding vectors 208 generated from the time-series actions to a known fraudulent event sequence to identify suspicious activity or fraudulent patterns.

In another embodiment, analytics module 206 may include a graph model. The graph model may link different embedding vectors 208 into one or more graphs. Each graph may show a relationship among the embedding vectors 208, which may indicate a relationship among different events, e.g., transactions made by different users, relationships among transactions and fraudulent products or services, computing device types, etc.

A graph model may also be included in an analytical pipeline that determines similar items. For example, analytics module 206 may perform an embedding vector similarity search to identify similar accounts and then connect those accounts in a graph database on one or more conditions. Example similar accounts may be accounts having a condition that is a similar event sequence or a similar avatar. Subsequently, when a computing device requests a search for similar accounts on the same condition, the graph model may access the graph database and retrieve the accounts connected using the condition.

In some embodiments, streaming platform 118 may store the analytics, including various counters, graphs, patterns, clusters, etc., that analytics module 206 generated for the embedding vectors 208 in feature storage 216. Feature storage 216 may be a database or another memory storage conducive for storing and retrieving large amount of data.

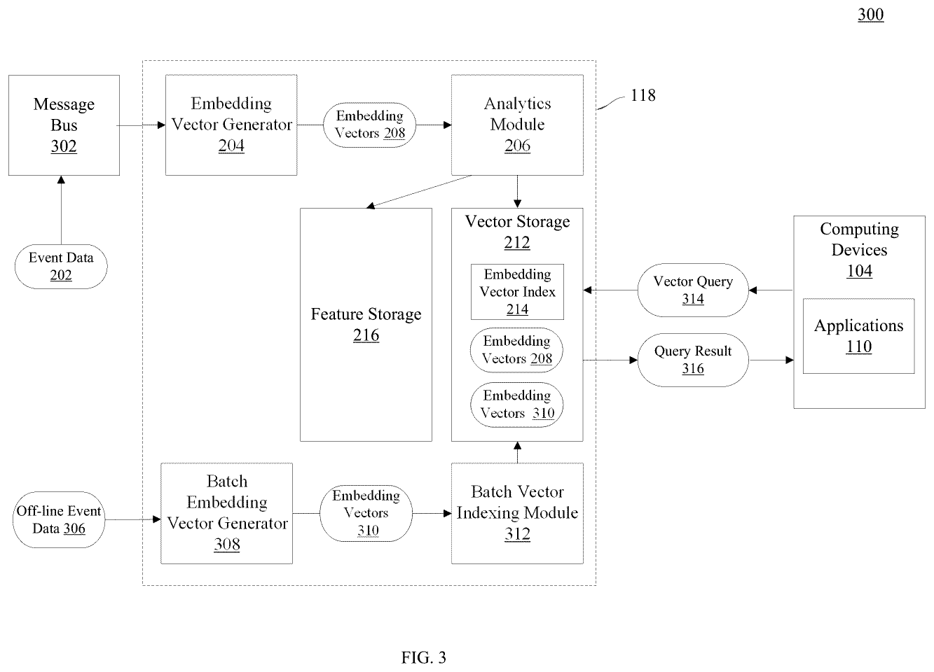

In some embodiments, embedding vectors 208 may be generated both in real-time as discussed above and off-line, in batches, at predefined timer intervals. The embedding vectors 208 generated in real-time and in batches may then be used to generate analytics, detect, fraud, provide recommendations, etc., in real-time to applications 110, 112. FIG. 3 is a flow diagram 300 for generating embedding vectors from events that occur in real-time and from batch data, according to some embodiments. In FIG. 3, streaming platform 118 may also include components for processing batch data, such as a batch embedding vector generator 308 and a batch vector indexing module 312.

As illustrated in FIG. 3, event data 202 may be data associated with events that occur in real-time in a network environment, such as system 100. Event data 202 may be transmitted to streaming platform 118 using a message bus 302. Message bus 302 may be software and/or hardware that receives event data 202, typically on first come basis, and aggregates event data 202 into a single message to be transmitted to streaming platform 118 at predefined time intervals. Because streaming platform 118 analyzes event data 202 in real-time, the predefined time intervals may be configurable and set to, for example, every second, every few seconds, or every minute.

Embedding vector generator 204 may receive event data 202 and generate embedding vectors 208 using embedding vector generator 204 as discussed in FIG. 2A. Analytics module 206 may then index embedding vectors 208 using vector indexing module 210 and analyze embedding vectors 208. The embedding vectors 208 and embedding vector index 214 may be stored in vector storage 212 and the results from the analysis that analytics module 206 generates may be stored in feature storage 216.

In some embodiments, vector storage 212 may also store embedding vectors and indices from off-line sources, while feature storage 216 may store analytics generated from off-line sources. For example, suppose system 100 collects off-line data. Off-line data may be off-line event data 306 that is associated with events that occurred in system 100 in the past, overnight, or over another time period that is not in real-time. Off-line data may be stored in a memory storage (not shown) conducive for storing large amounts of data. A batch embedding vector generator 308 may receive event data 306. Batch embedding vector generator 308 may be the same component as embedding vector generator 204 in some embodiments. Typically, batch embedding vector generator 308 may receive event data 306 at initialization, at night, once an hour, once a day, once a week, etc., and/or during time periods when system 100 experiences down time in system activity. Batch embedding vector generator 308 may convert event data 306 into embedding vectors 310 and pass embedding vectors 310 to batch vector indexing module 312. Batch vector indexing module 312 may be the same or different software as vector indexing module 210 discussed in FIG. 2A. Batch vector indexing module 312 may receive embedding vectors 310 generated from event data 202 and generate or update indices, such as embedding vector index 214 using embedding vectors 310 and store the indices in vector storage 212 as discussed above. Streaming platform 118 may also perform analytics on embedding vectors 310 as discussed above and store the results of the analytics in feature storage 216.

As embedding vector generator 204 generates embedding vectors 208 from event data 202 in real-time, analytics module 206 may update indices that were generated using batch vector indexing module 312 with indexes from embedding vectors 208. In some instances, when analytics module 206 generates analytics in real-time, analytics module 206 may generate analytics based on embedding vectors 208 and embedding vectors 310.

In some embodiments, vector storage 212 and feature storage 216 may be divided into an on-line storage and an off-line storage (not shown). The on-line storage may smaller than the off-line storage and may store a subset of recently used or accessed embedding vectors 208, 310 and features that correspond to the embedding vectors 208, 310. On-line storage may also be designed for faster access than off-line storage. In this way, embedding vectors 208, 310 that are stored in the on-line storage may be accessed more quickly relative to embedding vector 208, 310 that are stored in off-line storage. After a predefined time period after one or more embedding vectors 208, 310 where stored in the on-line storage or after a predefined time period since one or more embedding vectors 208, 310 were accessed in the on-line storage, embedding vectors 208, 310 may be moved or marked to be moved to the off-line storage. In some instances, the indices associated with embedding vectors 208, 310 may access both the on-line storage and the off-line storage.

Computing devices 104 that execute applications 110 (or other components in system 100) may query vector storage 212 and feature storage 216 using queries 314. Queries 314 may be a queries for a one or more embedding vectors 208 and/or 310, or a search queries for similar embedding vectors in embedding vectors 208, 310 that may satisfy criteria in the query. In response, embedding vector storage 212 and feature storage 216 may provide responses 316 with one or more embedding vectors 208 and/or 310, a list of embedding vectors 208, 310, or features that satisfy criteria in queries 314. As discussed above, application 110 may be associated with a merchant or service provider that allows a user to browse or purchase a product, in which case query 314 may be for embedding vectors 208, 310 of similar products that are being purchased by a user using application 110, and response 316 may include embedding vectors 208, 310 that correspond to similar products or the products themselves. In another example, application 110, 112 may be a risk management application that detects fraud, in which case the query 314 may be associated with a transaction and response 316 includes a list of embedding vectors 208, 310 of similar transactions or the similar transactions. Application 110, 112 may then determine based on the list of embedding vectors 208, 310 of similar transactions whether a transaction associated with event data 202 is a fraudulent transaction. In another example, application 110 may be a document editing application. In this case, embedding vectors 208 for a document may include a first embedding vector that includes a user signature, a second embedding vector that includes document content, and a third embedding vector that includes a document abstract. The first, second, and third embedding vectors may be stored in different namespaces in vector storage 212. Application 110, 112 generates query 314 the may request embedding vectors 208, 310 with an abstract on a particular topic. Response 316 may include embedding vectors 208, 310 with the abstract on that topic. Query 314 may further include a filter that filters the particular topic by authors with a last name starting with a letter “A”. Response 316 may include embedding vectors 208, 310 with the abstract on the particular topic with the authors with last names starting with the letter “A”.

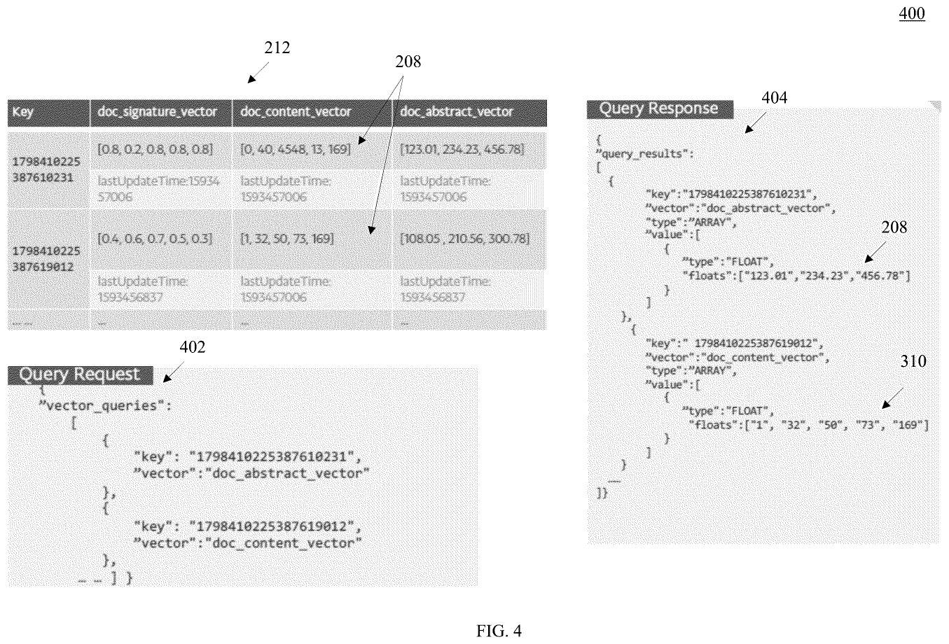

FIG. 4 is a diagram 400 of a vector query and query response, according to some embodiments. A vector query and response query may retrieve embedding vectors 208 and/or 310, though for simplicity embedding vectors 208 are shown. FIG. 4 illustrates a snapshot of embedding vector indexes 214. Vector storage 212 may include three namespaces that store three different types of embedding vectors, “doc_signature_vector” namespace with embedding vectors associated with a user signature, “doc_content_vector” namespace with embedding vectors associated with the document content, and “doc_abstract_vector” namespace with embedding vectors associated with the document abstract. Each of the three types of embedding vectors is associated with a particular document which may be identified using a key. The embedding vectors associated with the same document may be accessed using the key and the namespace. Further, vector storage 212 may also include time stamps indicative of the last time the embedding vectors 208 within the namespace were updated in real-time using embedding vector generator 204 or batch embedding vector generator 308.

The example vector query 402 may include a request for embedding vectors having type “doc_abstract_vector” and “doc_content_vector.” Additionally, to retrieve embedding vectors associated with a particular document, vector query 402 may include a key. Vector storage 212 may use a key and embedding vector index 214 to retrieve data for a query response 404. Notably, the embodiment is not limited to querying two embedding vectors 208 and may be configured to query any number of embedding vectors 208.

The example query response 404 may include a key included in vector query 402, a namespace included in vector query 402, and the embedding vectors 208. Notably, the example vector query 402 and query response 404 shown in FIG. 4 are exemplary as embedding vector storage 212 may receive different vector queries and query responses.

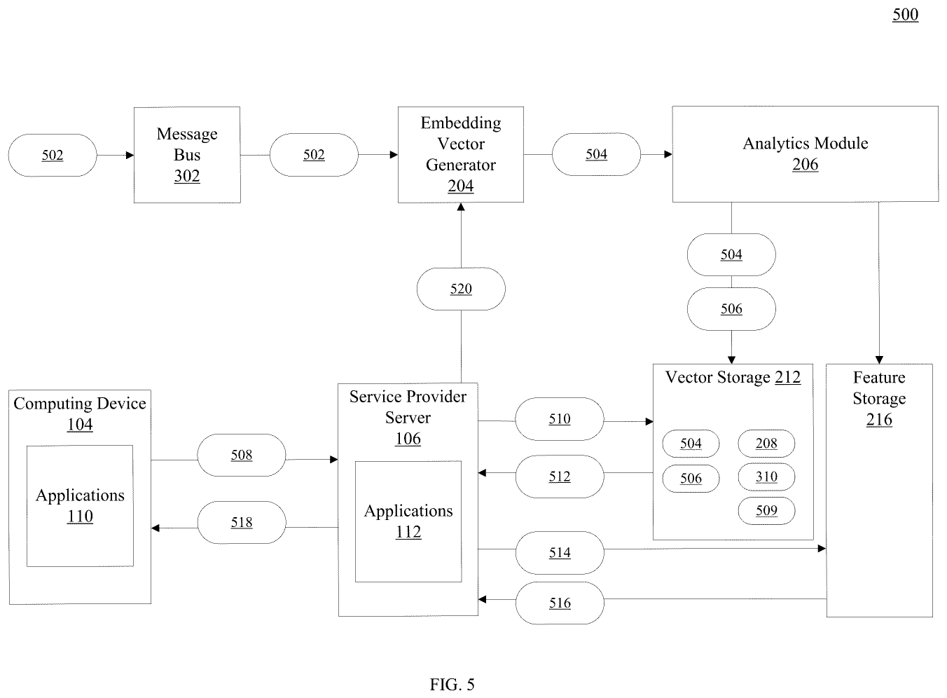

FIG. 5 is a flow diagram 500 for using embedding vectors that provide real-time recommendations based on similar embedding vectors, according to some embodiments. As discussed above, system 100 may use streaming platform 118 to provide recommendations for similar products. For example, suppose an event occurs in system 100 that corresponds to a product offer event generated by one of computing devices in system 100 with a limited time discount offer for a product. An event data 502 associated with the event may include the product information and offer information and may be transmitted using message bus 302 to embedding vector generator 204. Embedding vector generator 204 may receive event data 502 and generate embedding vector 504 from the product and/or offer information in event data 502. Analytics module 206 may receive embedding vector 504 and generate one or more indices 506 for one or more embeddings in embedding vector 504. Analytics module 206 may store embedding vector 504 associated with event data 502 and the indices 506 for embedding vector 504 in vector storage 212. Additionally, analytics module 206 may also perform analytics discussed in FIG. 2A using embedding vector 504 and store the results of the analytics in feature storage 216 (not shown).

In some embodiments, application 110 executing on computing device 104 may display a recommendation for product associated with the product offer event to a user. As the user is viewing products on application 110 or is otherwise interacting with application 110, e.g., providing instructions to purchase a product, application 110 may transmit a message 508 to application 112 executing on service provider server 106. Message 508 may include product information associated with the user interaction. For example, if application 110 received instructions to purchase a product or that the user is viewing the product, application 110 may generate message 508 that includes product information and/or instructions to purchase the product.

In some embodiments, application 112 may provide an interface to application 110 for purchasing a product and may also be a recommendation application that provides application 110 with similar products to those included in message 508. These products may be products that may be recommended to a user via application 110 based on a perceived interest in the product information included in message 508. The embodiments below describe how a product for which a product offer is occurring may be recommended to a user using application 110. Further, application 112 may provide recommendations for products in real-time or as close to real-time as technologically possible, e.g., every few seconds, a minute, etc., or during the time period the user is browsing or purchasing products via application 110.

For example, application 112 may generate a vector query 510 that includes a product identifier of a product associated with message 508 to vector storage 212. The product identifier may be linked to a key that is associated with one of the embedding vectors 208 or embedding vectors 310 for the product. In embodiments that do not involve a product, vector query 510 may include another identifier that links data to a key. In response, vector storage 212 may use indices 506 to retrieve an embedding vector 509 from embedding vectors 208 or 310 that is associated with the product and transmit a query response 512 that includes embedding vector 509 to application 112.

Once application 112 receives embedding vector 509 for the product in query response 512, application 112 may use the embedding vector 509 to identify similar products to the product. For example, application 112 may generate a search query 514. Search query 514 may include embedding vector 509 for a product received in query response 512. Additionally, search query 514 may also include one or more criteria that further filters the potential results. Example filters may include characteristics of a product that application 112 received in message 508. The feature storage 216 may receive search query 514 and may perform a search using embedding vector 509. In some instances, the search may use indices 506 in vector storage 212. An example search may be an ANN search and/or a top-k search. Feature storage 216 may generate a search response 516 that includes similar products or identifiers for the similar products. In some instances, search response 516 may also include a similarity distance that indicates how similar the similar products are the product included in message 508. The similarity distance may be based on values between one or more embeddings in embedding vector 509 and the similar embedding vectors 208, 310, and/or 504. Once feature storage 216 generates search response 516, feature storage 216 may transmit the search response 516 to application 112.

Application 112 may retrieve the similar products from search response 516. In some instances, application 112 may generate message 518 and provide some or all similar products to application 110 in message 518 to be displayed to a user. Notably, the interaction between application 110, application 112, and vector storage 212 and feature storage 216 may occur in real-time as application 110 is receiving instructions from the user to browse or purchase products. Accordingly, application 110 may receive similar products to the product as a user is browsing or purchasing products via application 110 in real-time.

In some embodiments, query response 512 may not include an embedding vector for a product included in message 508. This may occur when an embedding vector has not been generated in real-time via embedding vector generator 204 of streaming platform 118 or via a batch embedding vector generator 308 discussed in FIG. 3. In this case, application 112 may generate a message 520 that includes the product information of a product that the user is browsing or purchasing using application 110, and transmit message 520 to embedding vector generator 204. Embedding vector generator 204 may use the product information in message 520 to generate embedding vector 509 in real-time, which may then be indexed in indices 506 and stored in vector storage 212. Application 112 may then make another vector query 510 to vector storage 212 and receive embedding vector 509 in query response 512 and may then use the embedding vector 509 to retrieve similar products from feature storage 216 as discussed above.

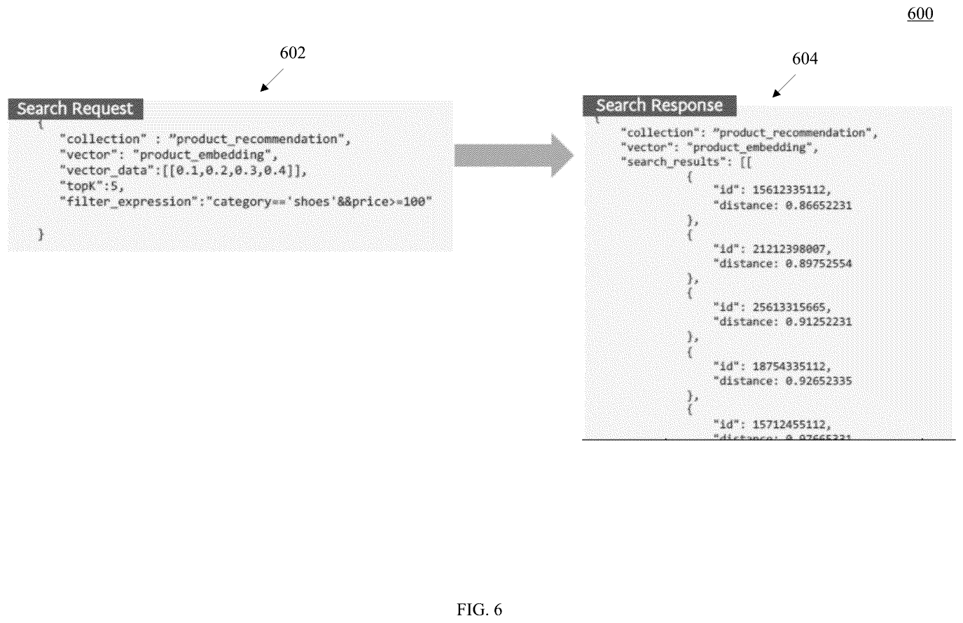

FIG. 6 is a diagram 600 of a search query and search response, according to some embodiments. FIG. 6 illustrates a search request 602 and search response 604. Search request 602 may be similar to search query 514 and search response 604 may be similar to search response 516 in some embodiments.

Search request 602 may include an embedding vector for a product (shown as “vector_data”), a namespace that stores the embedding vector (shown as “product_embedding”) that may search to identify similar embedding vectors, and a filter (shown as “filter_expression”) that may be used to set criteria to filter similar embedding vectors. Search request 602 may also include a setting for a maximum number of similar products (shown as “topK”).

Search response 604 may include identifiers (shown as “id”) of similar products or events that may include embedding vectors that are similar to the embedding vector in search request 602. Additionally, search response 604 may also include a similarity distance (shown as “distance”) that indicates how similar the embedding vectors of products that correspond to identifiers are to the embedding vector in search request 602.

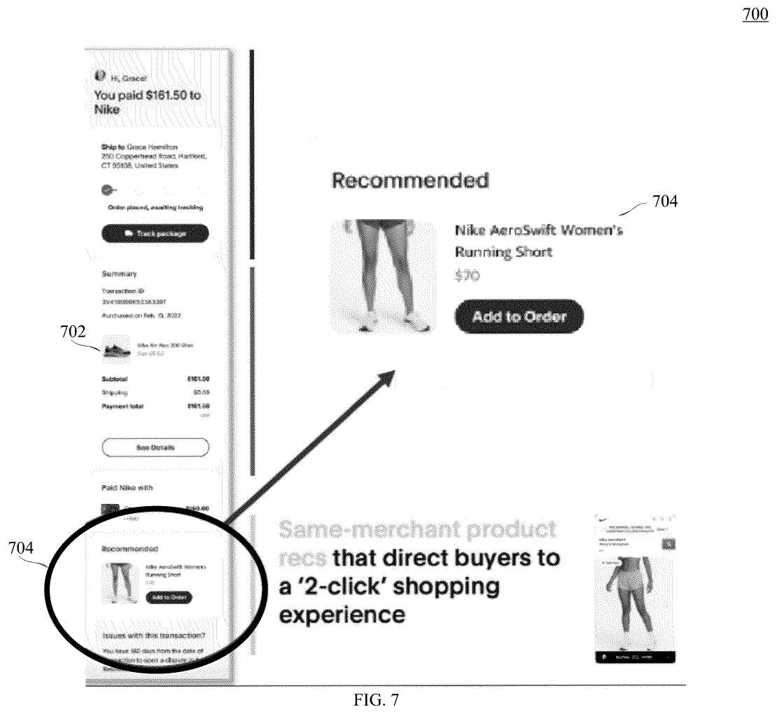

FIG. 7 is a diagram 700 of a display illustrating an interface with an item recommended using an embedding vector of another item in real-time, according to some embodiments. The recommended item in FIG. 7 may be shorts 704 and the item based on which a recommendation was made is a pair of sneakers 702.

FIG. 7 illustrates an interface shown on a display of application 110 executing on a computing device 104. The example application may be a browser or another application illustrating a shopping cart at a digital merchant store which a user manipulates to purchase the pair of sneakers 702. With reference to FIG. 5, the application 112 may be a counterpart to application 110 that receives requests to process transactions on behalf of application 110. Application 112 may also be a recommendation application which may identify similar products to display to a user using application 110. As application 112 processes a transaction originating at application 110, application 112 may receive product information for an item (e.g., sneakers) in the transaction. Using the product information, application 112 may generate vector query 510. In response, application 112 may receive embedding vector 509 for the pair of sneakers 702 in real-time. Application 112 may then generate search query 514 with the embedding vector 509 and receive search response 516 that includes similar products, such as running shorts 704 from the same brand. Application 112 then generates message 518 that includes the running shorts 704 to be displayed on an interface of application 110 in real-time as the user completes the purchase for the pair of sneakers 702.

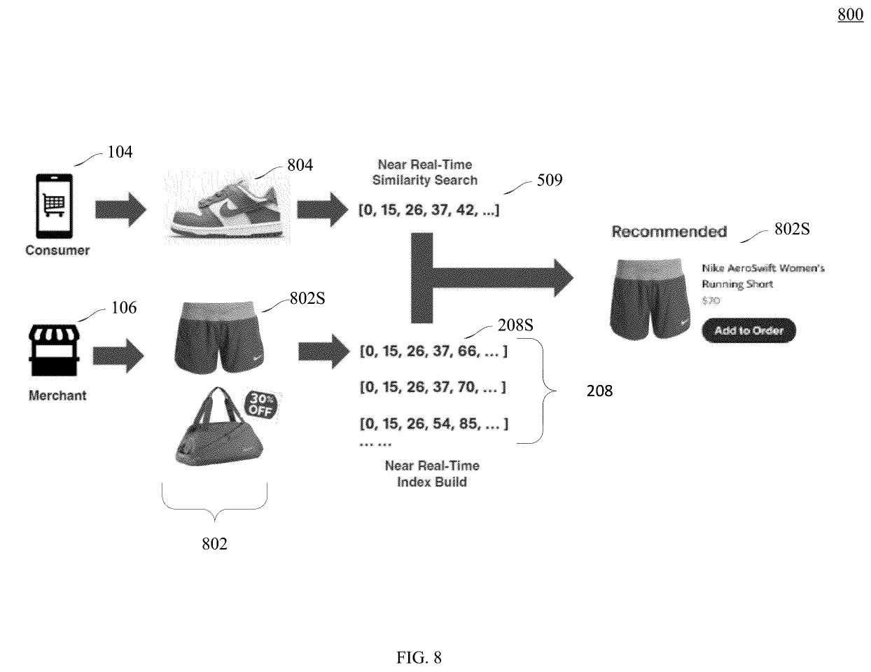

FIG. 8 is a flow diagram 800 of an item recommended using embedding vectors of other items in real-time, according to some embodiments. FIG. 8 illustrates a service provider server 106, which may execute an application of a merchant digitally selling products 802, such as sportswear, including shorts and sports bags. The merchant may also offer promotions for the sportswear. Embedding vector generator 204 of streaming platform 118 discussed in FIGS. 3 and 5 may generate embedding vectors 208 in real-time as the promotion occurs and analytics module 206 may generate analytics associated with embedding vectors 208, set indices, such as embedding vector index 214 on embedding vectors 208 in real-time and store embedding vectors 208 and indices in vector storage 212.

In some embodiments, a user using computing device 104 may view, select, or otherwise interact with a product 804 displayed on a display screen of computing device 104. An example product 804 may be a pair of sneakers. Computing device 104 may access a recommendation system, which may be another application 112 discussed in FIGS. 3 and 5. The recommendation system may receive product information for the product 804, e.g., a pair of sneakers, and request embedding vector 509 associated with the product from vector storage 212. Using the embedding vector 509 for the product, the recommendation system may retrieve similar embedding vectors 208 to the embedding vectors 509 using indices, such as, embedding vector index 214. Example similar embedding vectors 208 may include embedding vector 208S, which may correspond to a product 802S that is shorts. The similarity between embedding vector 509, which is [0, 15, 26, 37, 42 . . . ] and embedding vector 208S, which is [0, 15, 26, 37, . . . ] may be identified using an index which is set of the first four attributes of the embedding vectors 208, 509. The recommendation system may identify the product 802S that corresponds to the embedding vector 208S in feature storage 216, and transmit the product information for product 802S to the computing device 104 in real-time as the user continues to interact with product 804.

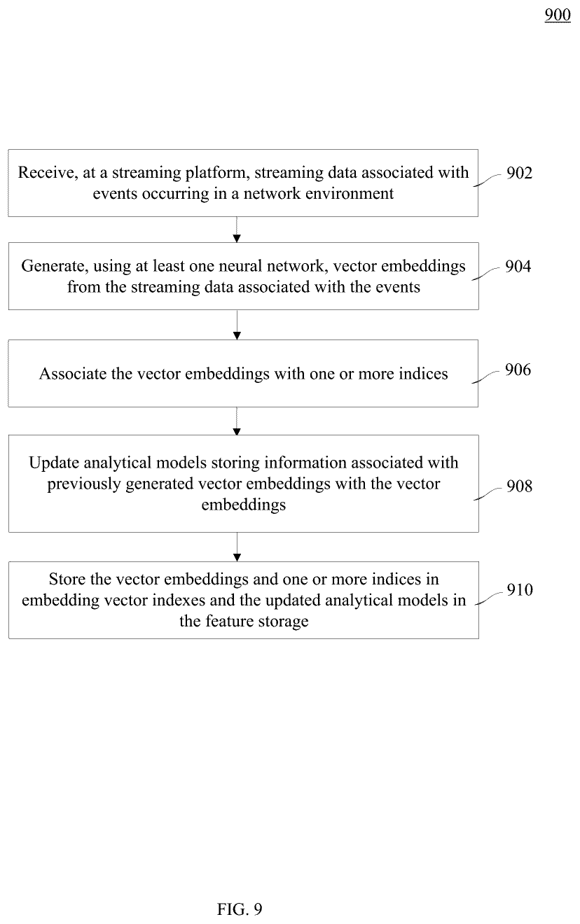

FIG. 9 is a flowchart of a method 900 for generating embedding vectors in real-time, according to some embodiments. Method 900 may be performed using hardware and/or software components described in FIGS. 1-8. Note that one or more of the operations may be deleted, combined, or performed in a different order as appropriate. Notably, operations 902-910 may occur in real-time or as closely to real-time as technologically possible.

At operation 902, streaming data associated with events occurring in a network environment is received. For example, streaming platform 118 may receive event data 202 that occurs in real-time in system 100.

At operation 904, embedding vectors are generated from the streaming data associated with the events. For example, streaming platform 118 may use embedding vector generator 204 to generate embedding vectors 208 from event data 202. The embedding vectors 208 may be generated using one or more neural network models.

At operation 906, embedding vectors are associated with indices. For example, vector indexing module 210 may set one or more indices on various attributes in embedding vectors 208 or update embedding vectors 208 with existing indices in embedding vector storage 212. The indices may be used for accessing and retrieving embedding vectors 208 or performing analytics on the embedding vectors 208.

At operation 908, analytical models are updated. For example, analytics module 206 may use analytical models that store information associated with previously generated embedding vectors with the embedding vectors 208.

At operation 910, embedding vectors, indices, and updated analytical models are stored. For example, the embedding vector 208 and indices may be stored in embedding vector storage 212 and the updated analytical models may be stored in feature storage 216.

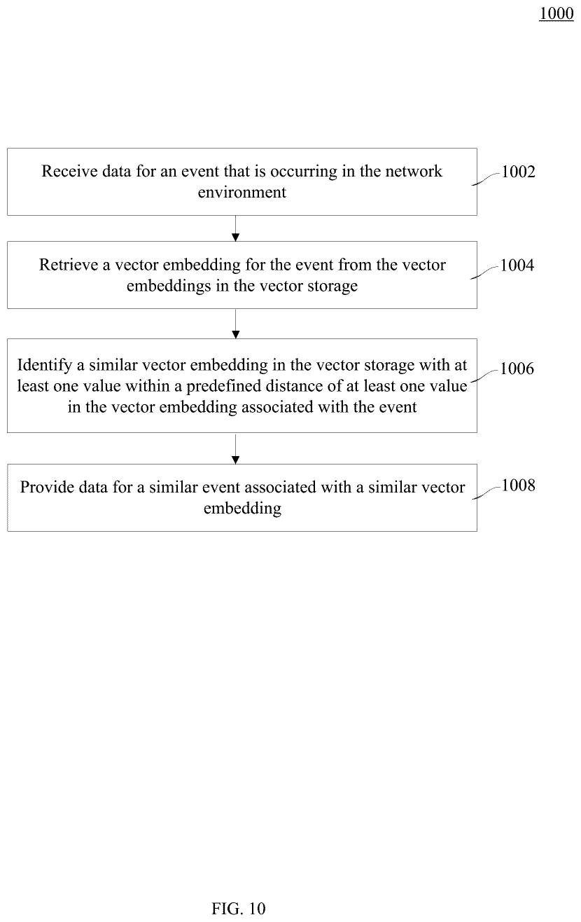

FIG. 10 is a flowchart of a method for identifying data in an event similar to data in another event using embedding vectors, according to some embodiments. Method 1000 may be performed using hardware and/or software components described in FIGS. 1-9. Note that one or more of the operations may be deleted, combined, or performed in a different order as appropriate. Notably, operations 1002-1008 may occur in real-time or as closely to real-time as technologically possible.

At operation 1002, data for an event is received. For example application 112 may receive event data 202 for an event that may be occurring in system 100. Event data 202 may be data associated with a user interacting with application 110 and selecting a product for purchase, viewing a textual document, or an image. Event data 202 may also be a transaction occurring in system 100 that may or may not be a fraudulent transaction, and the like. Application 110 may send event data 202 associated with an event in real-time to application 112, which may be a recommendation system, a fraud detection system, and the like.

At operation 1004, an embedding vector is retrieved. For example, application 112 may use the event data 202 associated with the event to generate vector query 510 to retrieve embedding vector for the event data, e.g., embedding vector 509, from embedding vector indexes 214 in query response 512. In instances where embedding vector 509 may not exist in embedding vector storage 214, streaming platform 118 may generate embedding vector 509 in real-time as discussed above and store embedding vector 509 in embedding vector storage 212 for subsequent retrieval.

At operation 1006, a similar embedding vector is identified. For example, application 112 may generate a search query 514 that includes embedding vector 509 to query embedding vector storage 212 for similar embedding vectors 208. Embedding vector storage 212 may use indices, such as embedding vector index 214, to identify similar embedding vectors 208 and return a search response 516 that includes the similar embedding vectors 208.

At operation 1008, data for a similar event is provided. For example, application 112 may identify similar items based on the similar embedding vectors 208 and return the similar events to application 110. Alternatively, feature storage 216 may also identify similar events, in which case search response 516 may include data associated with the similar events instead of embedding vectors 208. In this case, application 112 may select all or a subset of the data associated with the similar events and provide the selected data to application 110. As discussed above, in case of a recommendation application, the data may be a recommendation for a similar product. In case of a fraud detection application, the data may include a similar transaction that is marked as fraudulent or non-fraudulent to indicate the likelihood of the event data received in operation 1002 being associated with a fraudulent or a non-fraudulent transaction.

Referring now to FIG. 11 an embodiment of a computer system 1100 suitable for implementing, the systems and methods described in FIGS. 1-10 is illustrated.

In accordance with various embodiments of the disclosure, computer system 1100, such as a computer and/or a server, includes a bus 1102 or other communication mechanism for communicating information, which interconnects subsystems and components, such as a processing component 1104 (e.g., processor, micro-controller, digital signal processor (DSP), graphics processing unit (GPU), etc.), a system memory component 1106 (e.g., RAM), a static storage component 1108 (e.g., ROM), a disk drive component 1110 (e.g., magnetic or optical), a network interface component 1112 (e.g., modem or Ethernet card), a display component 1114 (e.g., CRT or LCD), an input component 1118 (e.g., keyboard, keypad, or virtual keyboard), a cursor control component 1120 (e.g., mouse, pointer, or trackball), a location determination component 1122 (e.g., a Global Positioning System (GPS) device as illustrated, a cell tower triangulation device, and/or a variety of other location determination devices known in the art), and/or a camera component 1123. In one implementation, the disk drive component 1110 may comprise a database having one or more disk drive components.

In accordance with embodiments of the disclosure, the computer system 1100 performs specific operations by the processor 1104 executing one or more sequences of instructions contained in the memory component 1106, such as described herein with respect to the mobile communications devices, mobile devices, and/or servers. Such instructions may be read into the system memory component 1106 from another computer readable medium, such as the static storage component 1108 or the disk drive component 1110. In other embodiments, hard-wired circuitry may be used in place of or in combination with software instructions to implement the disclosure.

Logic may be encoded in a computer readable medium, which may refer to any medium that participates in providing instructions to the processor 1104 for execution. Such a medium may take many forms, including but not limited to, non-volatile media, volatile media, and transmission media. In one embodiment, the computer readable medium is non-transitory. In various implementations, non-volatile media includes optical or magnetic disks, such as the disk drive component 1110, volatile media includes dynamic memory, such as the system memory component 1106, and transmission media includes coaxial cables, copper wire, and fiber optics, including wires that comprise the bus 1102. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read. In one embodiment, the computer readable media is non-transitory.

In various embodiments of the disclosure, execution of instruction sequences to practice the disclosure may be performed by the computer system 1100. In various other embodiments of the disclosure, a plurality of the computer systems 1100 coupled by a communication link 1124 to the network 102 (e.g., such as a LAN, WLAN, PTSN, and/or various other wired or wireless networks, including telecommunications, mobile, and cellular phone networks) may perform instruction sequences to practice the disclosure in coordination with one another.

The computer system 1100 may transmit and receive messages, data, information and instructions, including one or more programs (i.e., application code) through the communication link 1124 and the network interface component 1112. The network interface component 1112 may include an antenna, either separate or integrated, to enable transmission and reception via the communication link 1124. Received program code may be executed by processor 1104 as received and/or stored in disk drive component 1110 or some other non-volatile storage component for execution.

Where applicable, various embodiments provided by the disclosure may be implemented using hardware, software, or combinations of hardware and software. Also, where applicable, the various hardware components and/or software components set forth herein may be combined into composite components comprising software, hardware, and/or both without departing from the scope of the disclosure. Where applicable, the various hardware components and/or software components set forth herein may be separated into sub-components comprising software, hardware, or both without departing from the scope of the disclosure. In addition, where applicable, it is contemplated that software components may be implemented as hardware components and vice-versa.

Software, in accordance with the disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the disclosure to the precise forms or particular fields of use disclosed. As such, it is contemplated that various alternate embodiments and/or modifications to the disclosure, whether explicitly described or implied herein, are possible in light of the disclosure. Having thus described embodiments of the disclosure, persons of ordinary skill in the art will recognize that changes may be made in form and detail without departing from the scope of the disclosure. Thus, the disclosure is limited only by the claims.

What is claimed is:

1. A method comprising:
receiving, at a streaming platform, streaming data associated with events occurring in a network environment;
generating, using at least one neural network, embedding vectors from the streaming data associated with the events;
associating, the embedding vectors with a plurality of indexes;
updating analytical models storing information associated with previously generated embedding vectors with the embedding vectors using the plurality of indexes, wherein the previously generated embedding vectors are associated with previously received data.

2. The method of claim 1, further comprising:
receiving data for a first event that is occurring in the network environment;
retrieving a first embedding vector for the data for the first event from the embedding vectors using at least one index in the plurality of indexes;
identifying a second embedding vector in the vector storage with at least one value within a predefined distance of at least one value in the first vector embedding; and
providing data for a second event associated with the second vector embedding.

3. The method of claim 2, wherein the providing the data for the second event occurs during the first event in the network environment.

4. The method of claim 2, wherein the providing the data for the second event occurs in real-time to the first event in the network environment.

5. The method of claim 2, wherein retrieving the first embedding vector further comprises:
retrieving an identifier associated with the data for the first event; and
retrieving, using the at least one index in the plurality of indexes, the first embedding vector associated with the identifier from the vector storage.

6. The method of claim 2, wherein the retrieving further comprises:
providing the data for the first event to the streaming platform;
generating, using the at least one neural network, the first embedding vector for the data for the first event; and
providing the first vector embedding.

7. The method of claim 2, further comprising:
generating at predefined time intervals and using the at least one neural network, batch embedding vectors from batch data associated with data for historical events;
associating, the batch embedding vectors with the plurality of indexes; and
updating, using the plurality of indexes, the analytical models with the batch embedding vectors.

8. A system comprising:
a memory storing a streaming platform; and
a processor coupled to the memory and configured to perform instructions, the instructions comprising:
receiving, at the streaming platform, streaming data associated with events occurring in a network environment;
generating, using at least one neural network, embedding vectors from the streaming data associated with the events;
associating the embedding vectors with a plurality of indexes; and
updating analytical models storing information associated with batch embedding vectors generated at initialization with the embedding vectors using the plurality of indexes, wherein the batch embedding vectors are associated with data from historical events.

9. The system of claim 8, further comprising:
receiving data for a first event that is occurring in the network environment;
retrieving a first embedding vector for the data for the first event from the embedding vectors using at least one index in the plurality of indexes;
identifying, using a similarity algorithm and the at least one index in the plurality of indexes, a second embedding vector in the vector storage that is similar to the first vector embedding; and
providing data for a second event associated with the second vector embedding.

10. The system of claim 9, wherein the providing the data for the second event occurs during the first event in the network environment.

11. The system of claim 9, wherein retrieving the first embedding vector further comprises:
retrieving an identifier associated with the data for the first event; and
retrieving, using the at least one index, the first embedding vector associated with the identifier.

12. The system of claim 9, wherein the retrieving further comprises:
providing the data for the first event to the streaming platform;
generating, using the at least one neural network, the first embedding vector for the first event; and
providing the first embedding vector.

13. The system of claim 8, wherein updating the analytical models further comprises:
updating, using a velocity model, a velocity counter with at least one embedding vector in the embedding vectors.

14. The system of claim 8, wherein updating the analytical models further comprises:
updating, using an event sequence model, a pattern associated with at least one embedding vector in the embedding vectors.

15. The system of claim 8, wherein updating the analytical models further comprises:
updating, using a graph model and at least one embedding vector in the embedding vectors, a graph associated with the events and previous events occurring in the network environment.

16. A non-transitory computer readable medium having instructions stored thereon, that when executed by a processor cause the processor to perform operations, the operations comprising:
receiving, at a streaming platform, streaming data associated with an event occurring in a network environment;
generating, using at least one neural network, embedding vectors from the streaming data associated with the event;
associating, the embedding vectors with an index divided into segments; and
storing, the embedding vectors and the index in an embedding vector indexes.

17. The non-transitory computer readable medium of claim 16, further comprising:
receiving data for a first event that is occurring in the network environment;
retrieving a first embedding vector for the data for the first event from the embedding vectors using the index in the embedding vector indexes;
generating a query using the first embedding vector;
receiving, based on the query, item identifiers and similarity scores, wherein the similarity scores identify similarity between the first embedding vector and second embedding vectors associated with the item identifiers; and
providing items associated with the item identifiers.

18. The non-transitory computer readable medium of claim 17, wherein the query further includes a filter and the item identifiers are further based on the filters.

19. The non-transitory computer readable medium of claim 17, wherein the providing the items occurs during the first event in the network environment.

20. The non-transitory computer readable medium of claim 17, further comprising:
generating a second query, wherein the second query includes a first item identifier and a namespace; and
wherein retrieving the first embedding vector is in response to the second query.
